(19) United States
(12) Patent Application Publication
(10) Pub. No.: US 2012/0248731 A1
(43) Pub. Date: Oct. 4, 2012

(54) Wheeled vehicle

(76) Inventor: Tianfu Li, Bloomfield Hills, MI (US)

(21) Appl. No.: 13/065,889

(22) Filed: Apr. 1, 2011

(51) Int. Cl. B62M 1/04; B62M 9/00

(52) U.S. Cl. 280/221

(57) ABSTRACT

A vehicle supported on driven wheels includes a frame supported on the wheels, a platform supported on the frame at a pivot, a flexible member including a first end secured to the platform at a first side of the pivot and a second end secured to the platform at a second side of the pivot opposite the first side, and a mechanism engaged with the member and driving the wheels in one rotation as the member reciprocates through the mechanism due to oscillation of the platform about the pivot.

### BACKGROUND OF THE INVENTION

1. Field of the Invention

This invention relates generally to an apparatus for foot-powered, wheeled vehicles such as skateboards, scooters and platforms

2. Description of the Prior Art

Self-propelled wheeled vehicles that operate without an auxiliary power, such as an engine or electric motor, transmit power produced by the rider-operator standing on the platform. Such vehicles convert that power to rotating power that drives the wheels of the vehicle, thereby propelling the vehicle on forward path. Devices of this kind include skateboards, scooters, sleds and bicycles.

Many of these devices provide only intermittent power to the wheels because the vehicle is pushed forward when the rider's foot touches the ground. Because one of the rider's feet must remain on the vehicle in order to support the rider, this foot does not participate in driving the wheels. Because the player must lower the other foot to touch the ground and lift it away from the ground repeatedly, skill and balance of the rider are essential to safe operation.

There is a need to provide a self-propelled vehicle in which both feet of the rider can impart rotational energy to the device to drive the wheels continuously and place the rider's feet where balance and stability are enhanced.

### SUMMARY OF THE INVENTION

A skateboard supported on driven wheels includes a frame supported on the wheels, a platform supported on the frame at a pivot, a flexible member including a first end secured to the platform at a first side of the pivot and a second end secured to the platform at a second side of the pivot opposite the first side, and a mechanism engaged with the member and driving the wheels in rotation as the member reciprocates through the mechanism due to oscillation of the platform about the pivot.

In a first embodiment, the rider applies downward force on the platform using both feet alternately to pivot the platform and drive front and rear wheels during each downward application of force. In a second embodiment, the rider applies downward force on the platform using both feet alternately to pivot the platform and drive rear wheels during each downward application of force, the front wheel being used to steer the skateboard. In a third embodiment, the rider applies downward force on the platform at one side of the pivot moving the chain in the drive direction, the force is relaxed, and the chain is drawn automatically through the drive mechanism in the opposite direction, thereby positioning the platform for the next application of another foot-powered driving force.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a side view of a skateboard showing a first embodiment of a mechanism for driving the front and rear wheels;

FIG. 2 is bottom view of the skateboard of FIG. 1 showing the wheels executing a left-hand turn;

FIG. 3 is a cross section of an overrunning clutch in the rear axle drive mechanism drive mechanisms;

FIG. 4 is a cross section of an overrunning clutch in the front axle drive mechanism;

FIG. 5 is a side view of a skateboard showing a mechanism for driving the rear wheels;

FIG. 6 is a bottom view of the skateboard of FIG. 5;

FIG. 7 is a perspective view of the rear drive mechanism of FIG. 5 looking laterally in the direction of FIG. 5;

FIG. 8 is a perspective view of an alternate embodiment of a rear drive mechanism; and

FIG. 9 is a front view of the front drive mechanism of FIG. 1.

### DESCRIPTION OF THE PREFERRED EMBODIMENT

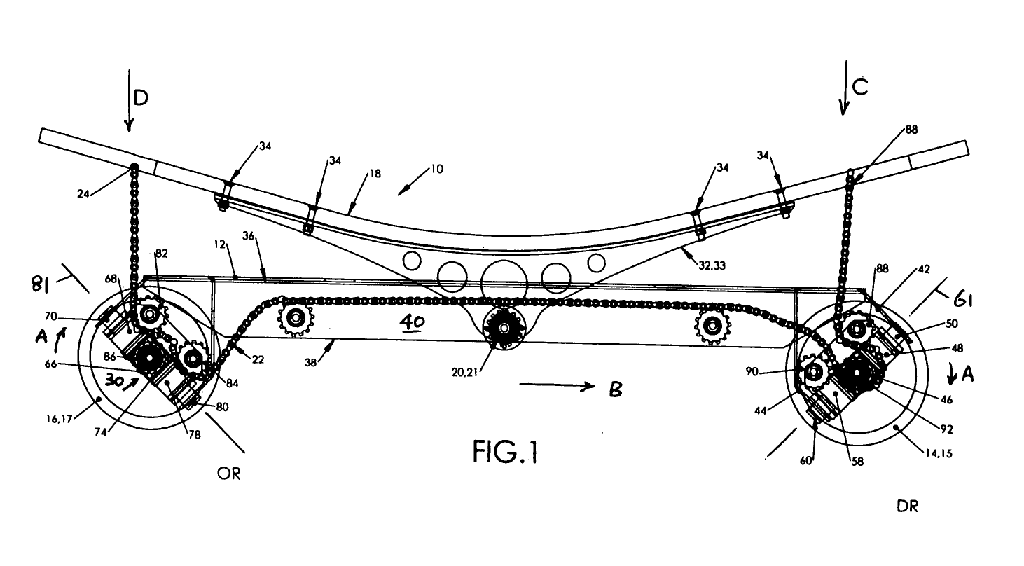

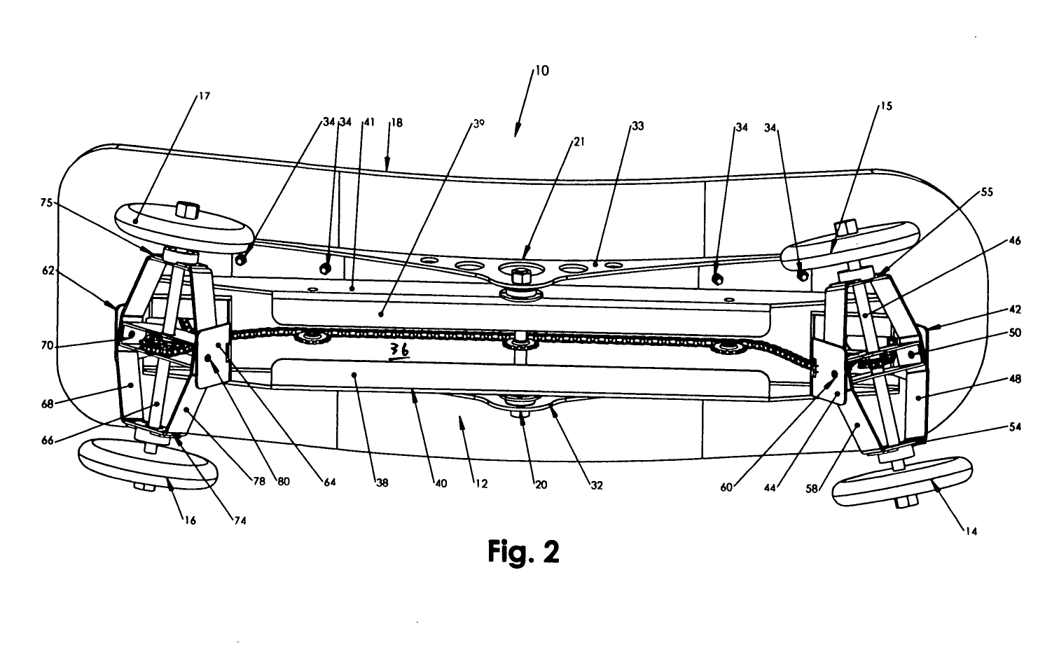

Referring first to FIGS. 1 and 2, a wheeled vehicle or skateboard 10 includes a frame 12 supported on two front wheels 14, 15 and two rear wheels 16, 17, a platform 18 supported on the frame at pivots 20, 21, a flexible member 22 having a first end 24 secured to the underside of the platform 18 at a first side of the pivot and a second end 26 secured to the platform at a second side of the pivot opposite the first side. The front wheels 14, 15 are driven in one rotary direction A by a front drive mechanism 28, which is engaged with the member 22. The rear wheels 16, 17 are also driven in rotary direction A by a rear drive mechanism 30, which is engaged with the member 22.

A rider standing on the platform 18 transfers his weight alternately to opposite side of the pivots 20, 21, causing the platform to oscillate about the pivots. Member 22 reciprocally travels in alternate directions through drive mechanisms 28, 30 and drives the wheels 14-17 in direction A as the platform oscillates. The skateboard 10 is driven in direction B as the wheels are driven by the rider's oscillating the platform.

Platform 18 includes plates 32, 33, each having an L-shaped cross section and lightening holes, the plates being secured by bolts or screws 34 to the underside of the platform and supported on frame 12 at the pivots 20, 21.

Frame 12 includes a horizontal upper plate 36, two horizontal lower flanges 38, 39, a vertical web 40 connecting the right-hand lateral edge of plate 36 and flange 38, and a vertical web 41 connecting the opposite lateral edge of plate 36 and flange 39. Frame 12 further includes legs 42, 44 secured to the underside of plate 36 at the front axle 46, on which the front wheels 14, 15 are supported. The front suspension includes an arm 48, which is secured at a pinned connection 50 to leg 42 and plates 54, 55, each plate located at a front wheel 14, 15 and supporting the front axle 46. The front suspension frame further includes an arm 58, which is secured at a pinned connection 60 to leg 44 and plates 54, 55. The pinned connections 50, 60 are aligned mutually on an axis 61.

The rear of frame 12 further includes legs 62, 64 secured to the underside of plate 36 and straddling the rear axle 66, on which the rear wheels 16, 17 are supported. A rear suspension frame includes an arm 68, which is secured at a pinned connection 70 to leg 62 and plates 74, 75, each plate located at a rear wheel 16, 17 and supporting the rear axle 66. The rear suspension frame further includes an arm 78, which is secured at a pinned connection 80 to leg 64 and plates 74, 75. The pinned connections 70, 80 are aligned mutually on an axis 82.

Axes 61 and 81 are inclined at about 45° with respect to the horizontal plane. The skateboard rider standing on platform 18 can produce left-hand and right-hand turns by transferring weight alternately to opposite lateral side of the platform, which causes the front wheels 14-15 to pivot about axis 61 and rear wheels 20, 21 to pivot about axis 81 in the direction that the rider has unbalanced the weight on the skateboard wheels.

The flexible member 22 may be a drive belt, adapted to driveably engage drive sheaves, or an articulating drive chain, adapted to driveably engage the teeth of sprocket wheels. FIGS. 1 and 2 show a chain 22 engaged with rear idler sprockets 82, 84, which are spaced angularly about rear axle 66 and are located radially with respect to sprocket 86 such that chain 22 rotates sprocket 86 in direction A when chain 22 travels forward through rear drive mechanism 30. Chain 22 also engages front idler sprockets 88, 90, which are spaced angularly about front axle 46 and are located radially with respect to sprocket 92 such that chain 22 rotates sprocket 92 in direction A when chain 22 travels forward through front drive mechanism 28.

The front drive mechanism 28 further includes an overrunning clutch 100, concentric with front axle 46 and located radially interior of sprocket 92 and radially exterior of axle 46. Similarly, the rear drive mechanism 30 further includes an overrunning clutch 102, which is concentric with rear axle 66 and located radially interior of sprocket 86 and radially exterior of axle 66.

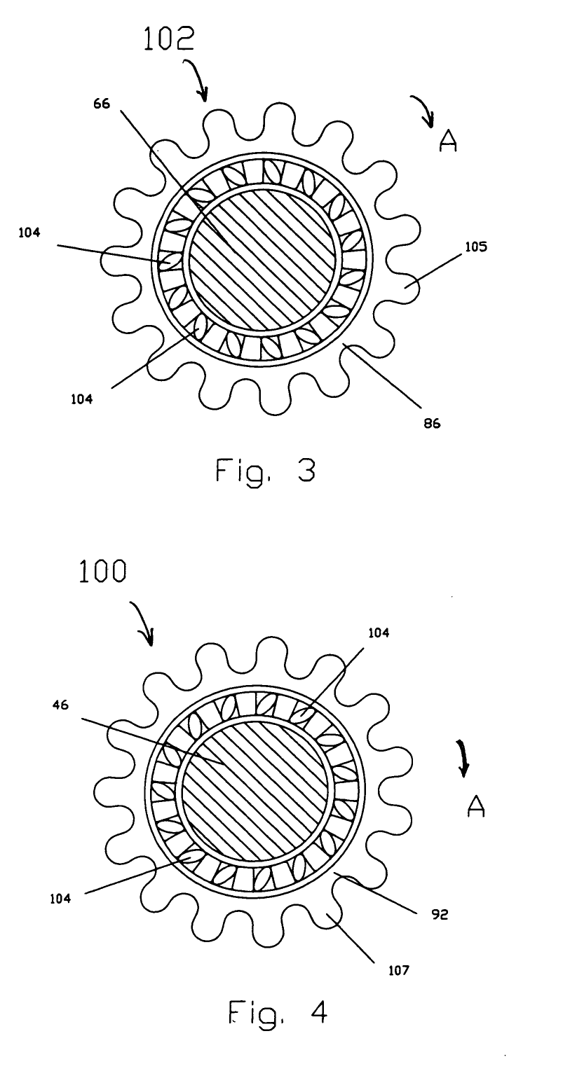

FIG. 3, a cross section of the overrunning clutch 102, shows a set of sprags 104, which are angularly spaced about the axis of rear axle 66. The sprags 104 are driveably engaged with sprocket wheel 86 and rear axle 66 when the sprocket 86 rotates in direction A, and they are driveably disengaged from sprocket 86 and rear axle 66 when sprocket 86 rotates opposite direction A. When member 22 is an articulating roller chain, the radial teeth 105 on the outer periphery of sprocket 86 are engaged by member 22. Sprocket 86 rotates in direction A when the front of platform 18 pivots upward.

FIG. 4, a cross section of the overrunning clutch 100, shows a set of sprags 104, which are angularly spaced about the axis of front axle 46. The sprags 104 are driveably engaged with sprocket 92 and front axle 46 when sprocket 92 rotates in direction A and are driveably disengaged from sprocket 92 and front axle 46 when sprocket 92 rotates opposite direction A. When sprockets 86, 92 are driven by member 22 in rotary direction A, the skateboard 10 is driven in direction B. When member 22 is an articulating roller chain, the radial teeth 107 on the outer periphery of sprocket 92 are engaged by member 22. Sprocket 86 rotates in direction A when the front of platform 18 pivots downward.

In operation, when the rider applies a downward force C at the forward side of pivots 20, 21, member 22 travels rearward through drive mechanisms 28, 30, the front one-way clutch 100 drives, the rear one-way clutch 102 overruns, front wheels 14, 15 are driven in direction A, and the skateboard is propelled forward in direction B. When the rider applies a downward force D at the rearward side of pivots 20, 21, member 22 travels forward through drive mechanisms 28, 30, the rear one-way clutch 102 drives, the front one-way clutch 100 overruns, rear wheels 16, 17 are driven in direction A, and the skateboard is propelled forward in direction B.

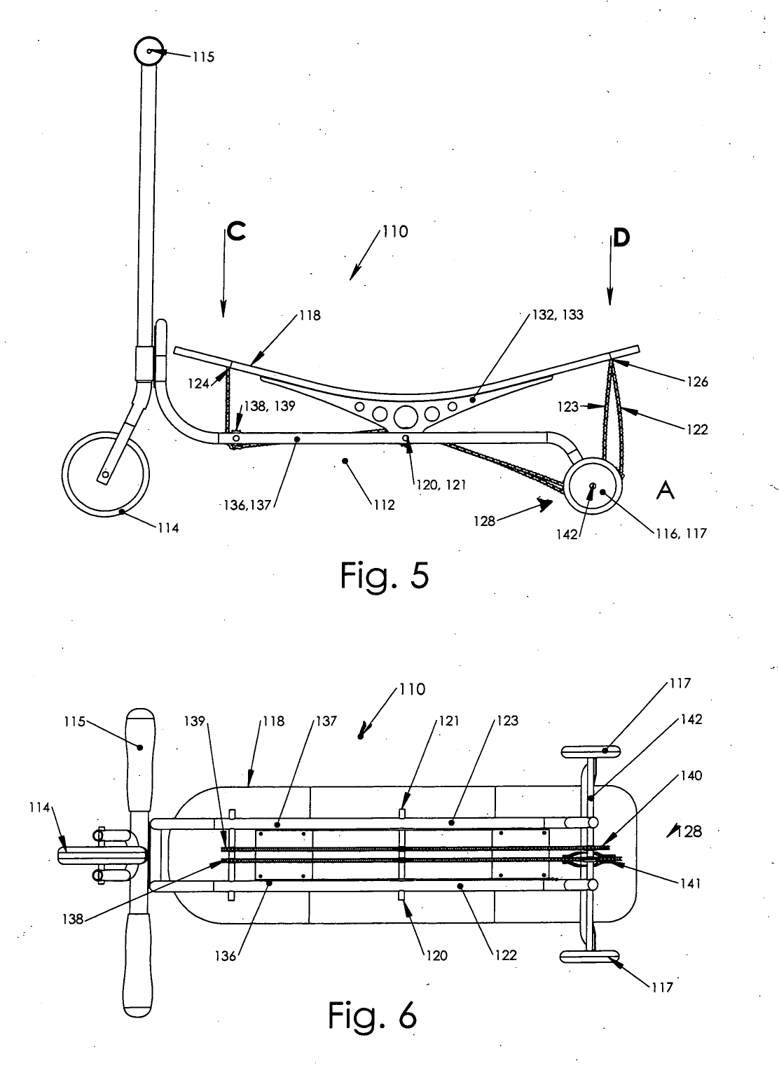

FIGS. 5, 6 and 7 illustrate a second embodiment of a wheeled vehicle or skateboard 110, which includes a frame 112 supported on one front wheel 114 and two rear wheels 116, 117, a platform 118 supported on the frame at pivots 120, 121, two flexible members 122, 123, each having a first end 124 secured to the underside of platform 118 at a first side of the pivots and a second end 126 secured to the underside of platform at a second side of the pivots opposite the first side. The rear wheels 116, 117 are also driven in rotary direction A by a mechanism 128, which is engaged with member 122, 123. The front wheel 114 is steered by the rider's control of a handlebar 115.

Members 122, 123 reciprocate synchronously along the length of the skateboard 110 and through the rear axle drive mechanism 128 as the platform 118 oscillates about pivots 120, 121. The skateboard 110 is propelled in linear direction B as the wheels 116, 117 are driven in rotary direction A as the platform 118 oscillates.

Platform 118 includes plates 132, 133, which are secured by bolts or screws to the underside of the platform, and is supported on frame 112 at the pivots 120, 121. Frame 112 includes horizontal rails 136, 137, and two front sprockets 138, 139 supported on the rails 136, 137 and engaged with the members 122, 123, respectively. The flexible members 122, 123 may be drive belts, adapted to driveably engage drive sheaves, or articulating drive chains, adapted to driveably engage the teeth of the sprockets 138, 139, 140, 141.

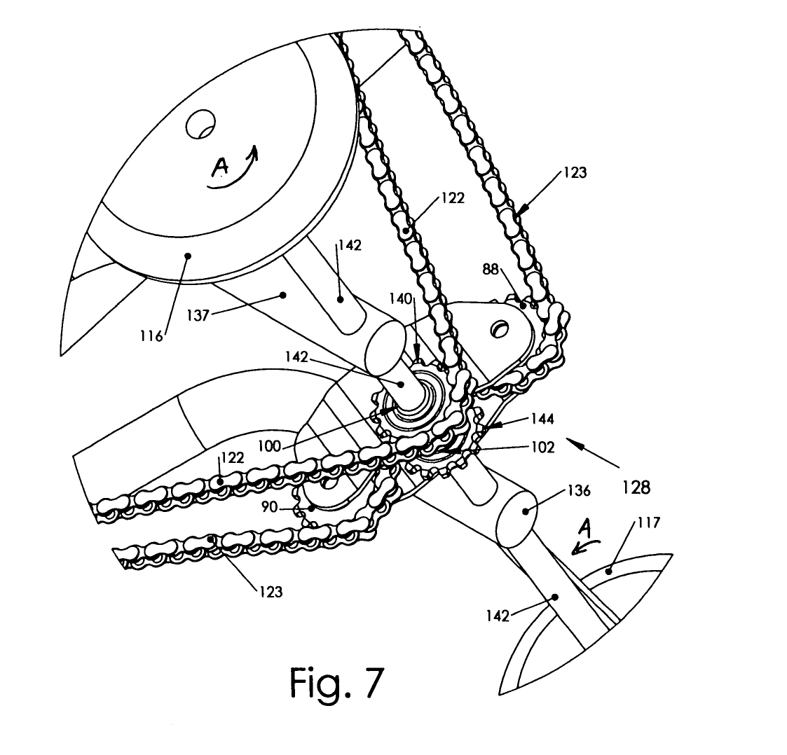

As FIG. 7 illustrates, the rear drive mechanism 128 includes a sprocket 140 engaged with chain 122 and supported on a rear axle 142, to which the wheels 116, 117 are connected. The rear drive mechanism 128 further includes a sprocket 141, which is engaged with chain 123 and supported on the rear axle 142, and two overrunning clutches 100, 102. When drive chains 122, 123 travel rearward, chain 122 rotates sprocket 140 counterclockwise and chain 123 rotates sprocket 141 clockwise, when viewed as shown in FIGS. 5 and 7. When drive chains 122, 123 travel forward concurrently, chain 122 rotates sprocket 140 clockwise and chain 123 rotates sprocket 144 counterclockwise. Drive member 123 also engages idler sprockets 88, 90, which are spaced angularly about axle 142 and located radially with respect to sprocket 141 such that chain 123 rotates sprocket 141 in direction A when member 123 travels forward through mechanism 128.

Overrunning clutch 100 is concentric with rear axle 142 and located radially interior of sprocket 140 and radially exterior of axle 142. Similarly, overrunning clutch 102 is concentric with rear axle 142 and located radially interior of sprocket 141 and radially exterior of axle 142. The sprags 104 of overrunning clutches 100, 102 are angularly spaced about the axis of rear axle 142.

When sprocket 140 rotates clockwise and sprocket 141 rotates counterclockwise, the sprags 104 of overrunning clutch 100 are driveably disengaged from sprocket 140 and rear axle 142, and the sprags 104 of overrunning clutch 102 are engaged with sprocket 144 and rear axle 142. In this operating mode, clutch 102 drives wheels 116, 117 in direction A and clutch 100 overruns and does not drive either wheel 116, 117.

When sprocket 140 rotates counterclockwise and sprocket 141 rotates clockwise, the sprags 104 of overrunning clutch 100 are engaged with sprocket 140 and rear axle 142, and the sprags 104 of overrunning clutch 102 are disengaged from sprocket 144 and rear axle 142. In this operating mode, clutch 100 drives wheels 116, 117 in direction A and clutch 102 overruns and does not drive either wheel 116, 117.

In operation, when the rider applies a downward force C on platform 118 at the forward side of pivots 120, 121, members 122, 123 travel rearward through drive mechanism 128, one-way clutch 100 drives the rear wheels 116, 117 in direction A, clutch 102 overruns, and the skateboard is propelled forward in direction B. When the rider applies a downward force D on platform 118 at the rearward side of pivots 120, 121, members 122, 123 travel forward through drive mechanism 128, one-way clutch 100 overruns, clutch 102 drives the rear wheels 116, 117 in direction A, and the skateboard is propelled forward in direction B.

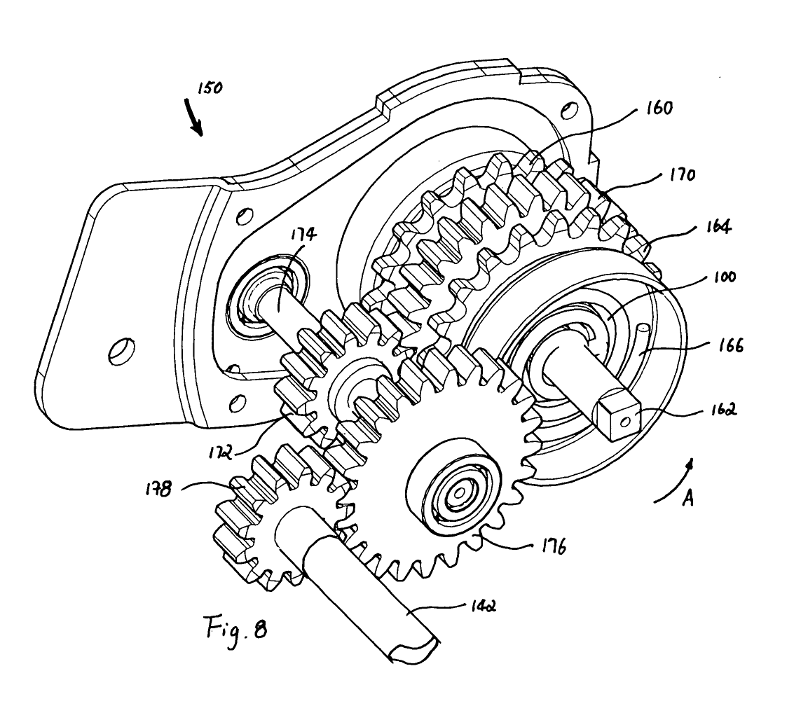

FIG. 8 illustrates an alternate rear drive mechanism 150 for a wheeled vehicle or skateboard 110. The rear drive mechanism 150 includes a sprocket 160 adapted for engagement with chain 122 and supported on a shaft 162, which is parallel to rear axle 142, to which the wheels 116, 117 are connected. The rear drive mechanism 150 further includes a sprocket 164 adapted for engagement with chain 123 and supported on shaft 162, two overrunning clutches 100, and two torsion springs 166.

The drive chain members 122, 123 reciprocate through mechanism 150. A first overrunning clutch 100 is concentric with shaft 162 and located radially interior of sprocket 164 and radially exterior of shaft 162. Similarly, the second overrunning clutch 100 is concentric with shaft 162 and located radially interior of sprocket 160 and radially exterior of shaft 162. The sprags 104 of both overrunning clutches 100 are angularly spaced about the axis of shaft 162. The sprags 104 are driveably engaged with sprocket wheels 160, 164 and shaft 162 when the sprockets 160, 164 rotate in direction A. Sprags 104 are driveably disengaged from sprockets 160, 164 and shaft 162 when the sprockets 160, 164 rotate opposite direction A. When sprockets 160, 164 are driven by chain drive members 122, 123 in rotary direction A, the skateboard 110 is driven in direction B.

Each torsion spring 166 includes one end secured to shaft 162 and an opposite end secured to a respective sprocket 160, 164, such that spring 166 is torsionally wound and preloaded by rotation of the sprocket in direction A. After each spring 166 is wound torsionally due to rotation of sprockets 160, 164 in direction A, spring 166 causes sprocket 164 to unwind and rotate opposite direction A.

A pinion 170, driveably connected to shaft 162, includes teeth in mesh with the teeth of a gear 172 supported on and driveably connected to a layshaft 174, which also supports a second pinion 176. Pinion 176 is driveably connected to layshaft 174 and its teeth are in mesh with the teeth of an output gear 178, driveably connected to rear axle 142.

In operation, when the operator applies a downward force on the platform 118 at the forward side of the pivots 120, 121, members 122, 123 drive sprockets 160, 164 and rear axle 142 in direction A, springs 166 become torsionally wound and preloaded, and the skateboard is propelled forward. But when the operator reduces the downward force, springs 166 unwind, platform 118 pivots in the opposite direction, members 122, 123 reverse their direction of travel though drive mechanism 150, sprockets 160, 164 rotate opposite direction A due to the torsion load transmitted to shaft 162 by torsion springs 166 as they unwind, and the one-way clutches 100 in mechanism 150 overrun allowing the rear wheels 116, 117 to coast in the forward direction until the rider again pivots the platform 118 by applying another downward force on the platform at the forward side of the pivots 120, 121.

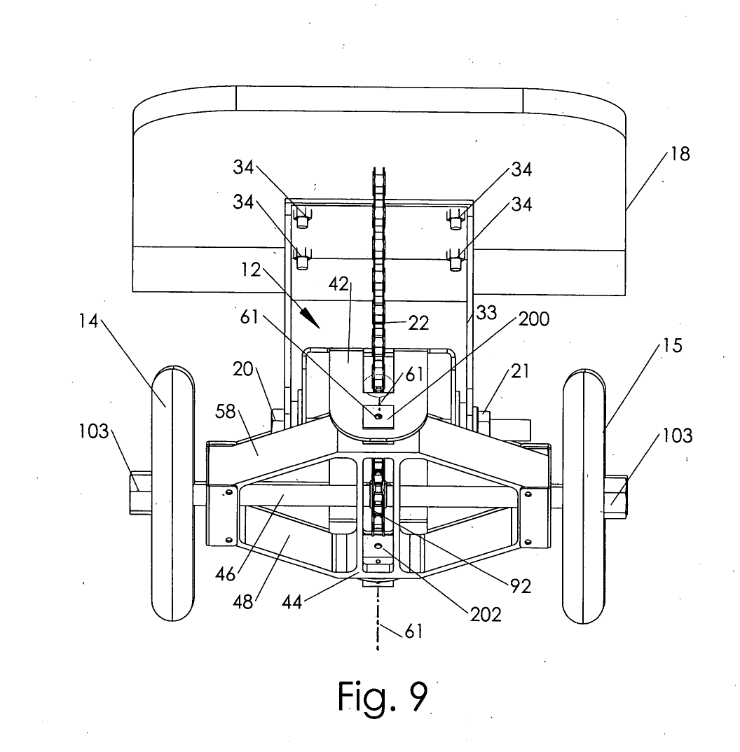

FIG. 9 illustrates the location of overrunning wheel clutches 103 at the front axle 46 of the embodiment of FIGS. 1 and 2. In order to provide differential front wheel speeds, an overrunning wheel clutch 103 is located in an annular space radially between front axle 46 and front wheel 14, and an overrunning wheel clutch 103 is located in an annular space radially between front axle 46 and rear wheel 15 in the embodiment of FIGS. 1 and 2. The overrunning clutch 103 that is located at wheel 14 permits wheel 14 to rotate faster than axle 46 and wheel 15 when the skateboard 10 is making a left-hand turn. The overrunning clutch 103 that is located at wheel 15 permits wheel 14 to rotate faster than axle 46 and wheel 14 when the skateboard is making a right-hand turn, as shown in FIG. 2. Each overrunning wheel clutch produces a one-way drive connection between the axle and one of the driven wheels that is supported on the axle.

Similarly, to provide differential rear wheel speeds, an overrunning wheel clutch 103 is located in an annular space radially between rear 66 and rear wheel 16, and an overrunning wheel clutch 103 is located in an annular space radially between rear axle 66 and rear wheel 17. The overrunning clutch 103 that is located at wheel 16 permits wheel 16 to rotate faster than axle 66 and wheel 17 when the skateboard 10 is making a left-hand turn. The overrunning clutch 103 that is located at wheel 17 permits wheel 17 to rotate faster than axle 66 and wheel 16 when the skateboard is making a right-hand turn, as shown in FIG. 2. Each overrunning wheel clutch produces a one-way drive connection between the axle and one of the driven wheels that is supported on the axle.

In order to provide differential rear wheel speeds, an overrunning wheel clutch 103 is located in an annular space radially between rear axle 142 and rear wheel 116, and an overrunning wheel clutch 103 is located between rear axle 142 and rear wheel 117 in the embodiments of FIGS. 5-8. The overrunning clutch 103 that is located at wheel 116 permits wheel 116 to rotate faster than axle 142 and wheel 117 when the skateboard 10 is making a right-hand turn. The overrunning clutch 103 that is located at wheel 117 permits wheel 117 to rotate faster than axle 142 and wheel 116 when the skateboard is making a left-hand turn. Each overrunning wheel clutch produces a one-way drive connection between the axle and one of the driven wheels that is supported on the axle.

FIG. 9 also shows that the front axle pinned connections 50, 60 illustrated in FIGS. 1 and 2 are replaced with flexible stub shafts 200, 202, respectively, each stub shaft having a rectangular cross section. Axis 61 is concentric with the axes of the stub shafts 200, 202. Stub shaft 200 is fitted into a rectangular hole formed in leg 42 and arm 48. Stub shaft 202 is fitted into a rectangular hole formed in leg 44 and arm 58. Similarly, the rear axle pinned connections 70, 80 illustrated in FIGS. 1 and 2 are replaced with flexible stub shafts 200, 202. Axis 81 is concentric with the axes of the stub shafts 200, 202 at the rear axle. Stub shaft 200 is fitted into a rectangular hole formed in leg 62 and arm 68. Stub shaft 202 is fitted into a rectangular hole formed in leg 64 and arm 78.

Preferably the stub shafts 200, 202 at the front and rear axles are formed of rubber or another flexible polymer, which permits bending flexibility when the skateboard makes right-hand and left-hand turns.

In accordance with the provisions of the patent statutes, the preferred embodiment has been described. However, it should be noted that the alternate embodiments can be practiced otherwise than as specifically illustrated and described.

What is claimed is:

1. A vehicle comprising:
a frame supported on wheels;
a platform supported on the frame at a pivot;
a member including a first end secured to the platform at a first side of the pivot and a second end secured to the platform at a second side of the pivot opposite the first side; and
a drive mechanism engaged with the member and driving at least two of the wheels in one rotary direction as the member travels through the mechanism due to oscillation of the platform about the pivot.

2. The vehicle of claim 1 further comprising:
first and second sets of wheels space mutually and located at opposite sides of the pivot; and
wherein the drive mechanism includes a first mechanism engaged with the member and driving the first set of wheels in one rotary direction as the member travels in a first direction through the first mechanism, and a second mechanism engaged with the member and driving the second set of wheels in said rotary direction as the drive member travels in a second direction opposite the first direction through the second mechanism.

3. The vehicle of claim 1 further comprising:
first and second wheels spaced mutually along an axle;
a sprocket wheel secured to the axle and engaged by the drive member;
an overrunning clutch that couples the axle and the sprocket wheel for rotation in said one rotary direction and that allows independent rotation of the axle relative to the sprocket wheel in the opposite rotary direction.

4. The vehicle of claim 1 further comprising:
first and second wheels spaced mutually along an axle;
a sprocket wheel secured to the axle, engaged by the drive member and supported for rotation in a plane about an axis of the axle;
idler wheels spaced radially from the sprocket wheel, supported for rotation in said plane, and driveably engaged with the drive member for maintaining the drive member engaged with the sprocket wheel; and
an overrunning clutch that couples the axle and the sprocket wheel for rotation in said one rotary direction and that allows independent rotation of the axle relative to the sprocket wheel in the opposite rotary direction.

5. The vehicle of claim 1 further comprising:
an axle supporting the driven wheels;
first overrunning wheel clutches, each of said first wheel clutches producing a one-way drive connection between the axle and one of the driven wheels that is supported on the axle.

6. The vehicle of claim 2 further comprising:
a front axle supporting the first set of wheels;
a front suspension including upper and lower front legs secured to the frame and formed with rectangular openings, and upper and lower front arms supporting the front axle and being formed with rectangular openings, the rectangular openings of the front arms and legs being mutually aligned; and
a upper front stub shaft formed of flexible material, fitted into the rectangular openings of the upper front arm and upper front leg and securing the upper front arm and upper front leg mutually;
a lower front stub shaft formed of flexible material, fitted into the rectangular openings of the lower front arm and lower front leg and securing the lower front arm and lower front leg mutually;
a rear axle supporting the second set of wheels;
a rear suspension including upper and lower legs secured to the frame and formed with rectangular openings, and upper and lower rear arms supporting the rear axle and being formed with rectangular openings, the rectangular openings of the rear arms and legs being mutually aligned;
a upper rear stub shaft formed of flexible material, fitted into the rectangular openings of the upper rear arm and upper rear leg, and securing the upper rear arm and upper rear leg mutually; and
a lower rear stub shaft formed of flexible material, fitted into the rectangular openings of the lower rear arm and lower rear leg, and securing the lower rear arm and upper rear leg mutually.

7. The vehicle of claim 1 further comprising:
first overrunning wheel clutches, each of said first wheel clutches producing a one-way drive connection between the front axle and one wheel of the first set of wheels; and
second overrunning wheel clutches, each of said second wheel clutches producing a one-way drive connection between the rear axle and one wheel of the second set of wheels.

8. A vehicle comprising:
first and second sets of wheels;
a frame supported on the wheels;
a platform supported on the frame at a pivot;
a drive member including a first end secured to the platform at a first side of the pivot and a second end secured to the platform at a second side of the pivot opposite the first side;
a first mechanism engaged with the drive member for driving the first set of wheels in a rotary direction as the drive member travels in a first direction through the first mechanism; and
a second mechanism engaged with the drive member for driving the second set of wheels in said rotary direction as the drive member travels in a second direction opposite the first direction through the second mechanism.

9. The vehicle of claim 8 wherein;
the first set of wheels is secured to a first axle and located at a first side of the pivot; and
the first mechanism includes a first sprocket engaged with the drive member, and a first overrunning clutch that driveably couples the first axle and the first sprocket for rotation in said one rotary direction as the drive member travels in a first direction through the first mechanism and that allows independent rotation of the first axle relative to the first sprocket wheel as the drive member travels in a second direction opposite the first direction through the first mechanism.

10. The vehicle of claim 8 wherein;
the second set of wheels secured to a second axle and located at opposite side of the pivot from the first set of wheels; and
the second mechanism includes a second sprocket engaged with the drive member, and a second overrunning clutch that driveably couples the second axle and the second sprocket for rotation in said one rotary direction as the drive member travels in a first direction through the second mechanism and that allows independent rotation of the second axle relative to the second sprocket as the drive member travels in a second direction opposite the first direction through the second mechanism.

11. The vehicle of claim 8 wherein;
the first set of wheels is secured to a first axle and located at a first side of the pivot;
the second set of wheels secured to a second axle and located at opposite side of the pivot from the first set of wheels;
the first mechanism includes a first sprocket engaged with the drive member, and a first overrunning clutch that driveably couples the first axle and the first sprocket for rotation in said one rotary direction as the drive member travels in a first direction through the first mechanism and that allows independent rotation of the first axle relative to the first sprocket as the drive member travels in a second direction opposite the first direction through the first mechanism; and
the second mechanism includes a second sprocket engaged with the drive member, and a second overrunning clutch that driveably couples the second axle and the second sprocket for rotation in said one rotary direction as the drive member travels in the second direction through the first mechanism and that allows independent rotation of the second axle relative to the second sprocket as the drive member travels in the first direction through the second mechanism.

12. The vehicle of claim 8 further comprising:
a front axle and a rear axle;
first overrunning wheel clutches, each of said first wheel clutches producing a one-way drive connection between the front axle and one wheel of the first set of wheels; and
second overrunning wheel clutches, each of said second wheel clutches producing a one-way drive connection between the rear axle and one wheel of the second set of wheels.

13. A vehicle supported on driven wheels comprising:
a set of wheels;
a frame supported on the wheels;
a platform supported on the frame at a pivot;
a first drive member including a first end secured to the platform at a first side of the pivot and a second end secured to the platform at a second side of the pivot opposite the first side;
a second drive member including a first end secured to the platform at a first side of the pivot and a second end secured to the platform at a second side of the pivot opposite the first side; and
a mechanism engaged with the first and second drive members for driving the wheels in a rotary direction as the drive members travel in a first direction through the mechanism, and for driving the wheels in said rotary direction as the drive members travels in a second direction opposite the first direction through the mechanism.

14. The vehicle of claim 13 wherein:
the wheels are secured to an axle; and
the vehicle further comprises:
a first sprocket engaged with the first drive member for rotation in a first rotary direction as the first drive member travels in a first direction through the mechanism; and
a first overrunning clutch that driveably couples the axle and the first sprocket for rotation in said one rotary direction as the drive member travels in a first direction through the first mechanism and that allows independent rotation of the axle relative to the sprocket as the drive member travels in a second direction opposite the first direction through the mechanism.

15. The vehicle of claim 13 wherein;
the wheels are secured to an axle; and
the vehicle further comprises:
a first sprocket engaged with the first drive member for rotation in a first rotary direction as the first drive member travels in a first direction through the mechanism; and
a first overrunning clutch that driveably couples the axle and the first sprocket for rotation in said one rotary direction as the drive member travels in the first direction through the first mechanism and that allows independent rotation of the axle relative to the first sprocket as the drive member travels in a second direction opposite the first direction through the mechanism;
a second sprocket engaged with the second drive member for rotation in a second rotary direction opposite the first rotary direction as the second drive member travels in the first direction through the mechanism; and
a second overrunning clutch that driveably couples the axle and the second sprocket for rotation in said one rotary direction as the drive member travels in the second direction through the mechanism and that allows independent rotation of the axle relative to the second sprocket as the drive member travels in the first direction through the mechanism; and
the second mechanism includes a second sprocket engaged with the drive member, and a second overrunning clutch that driveably couples the second axle and the second sprocket for rotation in said one rotary direction as the drive member travels in a first direction through the second mechanism and that allows independent rotation of the second axle relative to the second sprocket as the drive member travels in a second direction opposite the first direction through the second mechanism.

16. The vehicle of claim 13 wherein the wheels are secured to an axle, and
the vehicle further comprises:
a shaft secured against rotation;
a first sprocket supported on the shaft and engaged with the first drive member for rotation in said rotary direction as the first drive member travels in the first direction through the mechanism;
a torsion spring secured to the shaft and the sprocket for alternately storing torque transmitted to the spring from the sprocket and transmitting torque to, the sprocket; and
a first overrunning clutch that driveably couples the axle and the first sprocket for rotation in said rotary direction as the drive member travels in the first direction through the first mechanism and that allows independent rotation of the axle relative to the sprocket as the drive member travels in a second direction opposite the first direction through the mechanism.

17. The vehicle of claim 13 wherein the wheels are secured to an axle, and
the vehicle further comprises:
a shaft secured against rotation;
a first sprocket supported on the shaft and engaged with the first drive member for rotation in the rotary direction as the first drive member travels in the first direction through the mechanism;
a second sprocket supported on the shaft and engaged with the second drive member for rotation in the rotary direction as the second drive member travels in the first direction through the mechanism;
a first spring secured to the shaft and the first sprocket for alternately storing torque transmitted to the first spring from the first sprocket and transmitting torque to the first sprocket;
a second torsion spring secured to the shaft and the second sprocket for alternately storing torque transmitted to the second sprocket and transmitting torque to the second sprocket;
a first overrunning clutch that driveably couples the axle and the first sprocket for rotation in said rotary direction as the drive member travels in the first direction through the mechanism and that allows independent rotation of the axle relative to the first sprocket as the drive member travels in a second direction opposite the first direction through the mechanism; and
a second overrunning clutch that driveably couples the axle and the second sprocket for rotation in said rotary direction as the drive member travels in the first direction through the mechanism and that allows independent rotation of the axle relative to the second sprocket as the drive member travels in the second direction through the mechanism.

18. The vehicle of claim 17 further comprising a gear train for transmitting torque from the sprockets to the axle.

19. The vehicle of claim 16 further comprising a gear train for transmitting rotary power from the sprockets to the axle and driving the axle at a greater speed than a speed of the sprockets.

20. The vehicle of claim 13 further comprising:
an axle supporting the wheels;
first overrunning wheel clutches, each of said first wheel clutches producing a one-way drive connection between the axle and a first wheel; and
second overrunning wheel clutches, each of said second wheel clutches producing a one-way drive connection between the axle and a second wheel.
